(19) United States
(12) Patent Application Publication
(10) Pub. No.: US 2024/0380310 A1
(43) Pub. Date: Nov. 14, 2024

(54) DISCHARGE CIRCUIT FOR DISCHARGING SMOOTHING CAPACITOR

(71) Applicant: DENSO CORPORATION, Kariya-city (JP)

(72) Inventors: Hiroshi SHIMIZU, Nisshin-city (JP); Harumi HORIHATA, Kariya-city (JP); Sadahiro AKAMA, Kariya-city (JP)

(73) Assignee: DENSO CORPORATION, Kariya-city (JP)

(21) Appl. No.: 18/783,963

(22) Filed: Jul. 25, 2024

Related U.S. Application Data
(63) Continuation of application No. PCT/JP2023/000632, filed on Jan. 12, 2023.

(30) Foreign Application Priority Data
Jan. 26, 2022 (JP) 2022-010496

(51) Int. Cl. H02M 1/32; H02M 7/48

(52) U.S. Cl. CPC H02M 1/322; H02M 7/48

(57) ABSTRACT

A discharge circuit discharges a smoothing capacitor that smooths a DC voltage through a plurality of resistive elements mounted on a substrate. The discharge circuit includes a series connection of at least three resistive elements spaced apart from each other in a first direction and connected in series by wires. The resistive element positioned more centrally in the first direction, included in the series connection, has a lower resistance value. The resistive elements adjacent to each other in the first direction and included in the series connection are displaced from each other in a second direction perpendicular to the first direction.

### CROSS-REFERENCE TO RELATED APPLICATION

This application is a continuation application of International Application No. PCT/JP2023/000632 filed Jan. 12, 2023 which designated the U.S. and claims priority to Japanese Patent Application No. 2022-010496 filed Jan. 26, 2022, the contents of each of which are incorporated herein by reference.

### BACKGROUND

### Technical Field

The present disclosure relates to a discharge circuit for discharging a smoothing capacitor that smooths a DC voltage.

### Related Art

Conventionally, a discharge circuit for discharging a smoothing capacitor that smooths DC voltages is known, in which N×M resistive elements are arranged in a two-dimensional grid pattern such that M resistor sets, each set consisting of N resistive elements connected in parallel, are connected in series.

### BRIEF DESCRIPTION OF THE DRAWINGS

In the accompanying drawings:

FIG. 1 is a circuit diagram of a control system for a rotating electric machine according to one embodiment;

FIG. 2 is a circuit diagram of the control system after a vehicle collision;

FIG. 3 is a perspective view of a discharge circuit;

FIG. 4 is a top view of the discharge circuit;

FIG. 5 is a side view of the discharge circuit;

FIG. 6 is a side view of the discharge circuit and cooler after encapsulation with resin;

FIG. 7 is a perspective view of the discharge circuit after encapsulation with resin;

FIG. 8A is a graph of target voltage of a smoothing capacitor versus time;

FIG. 8B is a graph of amount of heat generation by each element versus time;

FIG. 9 is a flowchart of a discharge control process;

FIGS. 10A-10C are graphs of amounts of heat generated by the resistive elements at different positions versus time;

FIG. 11 is a graph illustrating a relationship between resistance value of an adjusting resistive element and gate voltage of a MOSFET;

FIG. 12A is a graph of voltage of the smoothing capacitor versus time;

FIG. 12B is graphs of amounts of heat generated by the resistive element and the MOSFET versus time;

FIG. 12C is a graph of on-resistance of the MOSFET versus time;

FIG. 13 is a graph of temperature of the discharge resistive element having the highest temperature;

FIG. 14 is a graph of temperature of the MOSFET 42;

FIG. 15 is a graph of temperature of the discharge resistive element having the highest temperature in a first example modification;

FIG. 16 is a graph of temperature of the discharge resistive element having the highest temperature in a second example modification; and

FIG. 17 is a graph of temperature of the discharge resistive element having the highest temperature in a third example modification.

### DESCRIPTION OF SPECIFIC EMBODIMENTS

The heat generated in adjacent resistive elements is conductive to each other via the wiring connecting them. For example, in the above known discharge circuit as disclosed in JP 2021-36754 A, N×M resistive elements are arranged in a grid pattern which allows the adjacent resistive elements to be connected by the shortest wires. This leads to an increased amount of heat conducted through the wiring connecting the adjacent resistive elements in the above discharge circuit. Thus, the resistive elements are less able to dissipate heat, and when the smoothing capacitor is discharged in a short time, the temperature of the resistive elements is likely to rise above the heat resistance temperature.

In view of the foregoing, it is desired to have a technique for discharging a smoothing capacitor in a discharge circuit in a shorter time and keeping the temperature of resistive elements at or below a heat resistance temperature.

A first aspect of the present disclosure provides a discharge circuit for discharging a smoothing capacitor that smooths a DC voltage through a plurality of resistive elements mounted on a substrate, including a series connection of at least three resistive elements spaced apart from each other in a first direction and connected in series by wires. The resistive element positioned more centrally in the first direction, included in the series connection, has a lower resistance value. The resistive elements adjacent to each other in the first direction and included in the series connection are displaced from each other in a second direction perpendicular to the first direction.

According to the above configuration, the discharge circuit discharges the smoothing capacitor that smooths the DC voltage through the plurality of resistive elements mounted on the substrate.

The discharge circuit includes a series connection of at least three resistive elements spaced apart from each other in the first direction and connected in series by wires. When a plurality of resistive elements connected in series by wires are aligned in the first direction, the resistive element in a more central position in the first direction has heat more concentrated thereto and it is harder to dissipate heat therefrom. In this respect, the resistive element positioned more centrally in the first direction, included in the series connection, has a lower resistance value. This can decrease an amount of heat generation by the resistive element positioned more centrally in the first direction, thereby suppressing the temperature of the resistive element from which it is harder to dissipate heat, to prevent it from exceeding a heat resistance temperature.

Since the resistive elements are connected in series by the wires, heat generated in the resistive elements is conducted to each other through the wires. Thus, in a case where there is a large amount of heat conducted to each other through the wires, heat becomes more difficult to dissipate from the resistive elements, and the temperature of each resistive element is liable to rise. In this regard, the resistive elements adjacent to each other in the first direction and included in the series connection are displaced from each other in the second direction perpendicular to the first direction. Therefore, the wires connecting the adjacent resistive elements in the first direction can be elongated or made longer, thereby suppressing the heat generated in the resistive elements from being conducted to each other through the wires. This can facilitate dissipating the heat generated in the resistive elements, thereby suppressing a rise in the temperature of each resistive element.

The above two advantages allow the smoothing capacitor to be discharged in a shorter time and also facilitates keeping the temperature of each resistive element at or below the heat resistance temperature.

Specifically, in a second aspect, an overlap range in the second direction perpendicular to the first direction where the resistive elements adjacent to each other in the first direction and included in the series connection overlap positionally in the second direction is less than half the length of each resistive element in the second direction. Such a configuration allows the wires connecting the resistive elements adjacent in the first direction to be further elongated or made longer, thereby suppressing the heat generated in the resistive elements from being conducted from the resistive elements to each other through the wires.

In a third aspect, each resistive element is a chip resistor and includes electrodes at both ends in the first direction, where each of these electrodes extends over the length of the resistive element in the second direction. An overlap range in the second direction where an overlap range in the second direction where the electrodes, each belonging to a different one of the resistive elements adjacent to each other in the first direction and included in the series connection, overlap positionally in the second direction is less than half the length of each resistive element in the second direction.

According to the above configuration, each resistive element is a chip resistor. Chip resistors are smaller in volume and have a smaller thermal capacity than common resistive elements, so the temperature of each chip resistor is liable to rise due to heat generation. Furthermore, each resistive element includes electrodes at both ends in the first direction, where each of the electrodes extends over the length of the resistive element in the second direction. Thus, the heat generated in resistive elements becomes more conductive from these electrodes over the length in the second direction to each other through the wires. In this regard, an overlap range in the second direction where an overlap range in the second direction where the electrodes, each belonging to a different one of the resistive elements adjacent to each other in the first direction and included in the series connection, overlap positionally in the second direction is less than half the length of each resistive element in the second direction. Therefore, the wires connecting the electrodes of the resistive elements, adjacent in the first direction, can be elongated or made longer, thereby suppressing the heat generated in the resistive elements from being conducted from the electrodes to each other through the wires.

In a fourth aspect, there is no overlap range in the second direction where the resistive elements adjacent to each other in the first direction and included in the series connection overlap positionally in the second direction. Such a configuration allows the wires connecting the resistive elements adjacent in the first direction to be further elongated or made longer, thereby suppressing the heat generated in the resistive elements from being conducted therefrom to each other through the wires. That is, in the discharge circuit where a plurality of resistive elements need to be arranged efficiently, heat dissipation from the resistive elements can be improved by daring to elongate the wires connecting the adjacent resistive elements in the first direction.

In a fifth aspect, a plurality of the resistive elements are mounted on each of the front side surface and the back side surface of the substrate. In the projection onto the front side surface, the area of overlap between each of the resistive elements mounted on the front side surface and each of the resistive elements mounted on the back side surface is less than half the area of each of the plurality of resistive elements. According to such a configuration, in the discharge circuit including a plurality of the resistive elements mounted on the front side surface of the substrate and a plurality of the resistive elements mounted on the back side of the substrate, the above configuration can decrease the area of overlap between each of the resistive elements mounted on the front side surface of the substrate and each of the resistive elements mounted on the back side surface of the substrate in the projection onto the front side surface. Therefore, an amount of heat conducted between the resistive elements mounted on the front side surface and the resistive elements mounted on the back side surface can be decreased, thereby improving the heat dissipation from each resistive element.

The larger the resistive elements are, the larger the portion of the resistive elements in contact with the wires and the substrate can be made, which facilitates heat dissipation from the resistive elements to the wires and the substrate.

In a sixth aspect, the size of each resistive element included in the series connection may be set larger as the resistive element is more centrally positioned in the first direction. Such a configuration can facilitate heat dissipation from the resistive element positioned more centrally, from which it is harder to dissipate heat, to the wires and the substrate, thereby suppressing the temperature of the resistive element positioned centrally from exceeding the heat resistance temperature.

In a seventh aspect, the plurality of resistive elements are encapsulated with a resin and thereby integrated into the substrate. Such a configuration allows the heat generated in the resistive elements to be conducted to the resin, and further allows the heat to be conducted from the resin to the substrate. Therefore, this can suppress a rise in the temperature of each resistive element.

In an eighth aspect, the resin has a flat surface portion formed, and a cooling member, which has a temperature lower than a temperature of the resin, is in contact with the flat surface portion. Such a configuration allows the resin encapsulating the resistive elements to be cooled by the cooling member, thereby further suppressing a rise in the temperature of each resistive element.

In a ninth aspect, the resin is provided on both sides of the substrate, and the thickness of the resin on the cooling member side of the substrate is thinner than the thickness of the resin on the opposite side of the substrate from the cooling member. Such a configuration allows the heat generated to be efficiently conducted from the resistive elements to the cooling member through the thinner resin on the cooling member side of the substrate. Furthermore, the thicker resin on the opposite side of the substrate from the cooling member can increase the heat capacity of the resin, thereby suppressing a rise in the temperature of each resistive element.

The thermal conductivity of common epoxy resin is in an order of 0.3 W/mK

In this respect, in a tenth aspect, the thermal conductivity of the resin is 0.6 W/mK or higher. Such a configuration allows heat conduction from the resistive elements to the resin to be promoted, and can further suppress a rise in the temperature of each resistive element.

In an eleventh aspect, wires which are connected to both ends of the smoothing capacitor, and wires which control current conduction to the resistive elements, extend from the substrate to the outside the resin. Such a configuration facilitates connecting the wires from the outside to the discharge circuit in a configuration where the resistive elements are encapsulated with the resin to be integrated into the substrate.

Hereinafter, a control system for a rotating electric machine mounted on an electric vehicle or the like according to one embodiment will now be described with reference to the accompanying drawings.

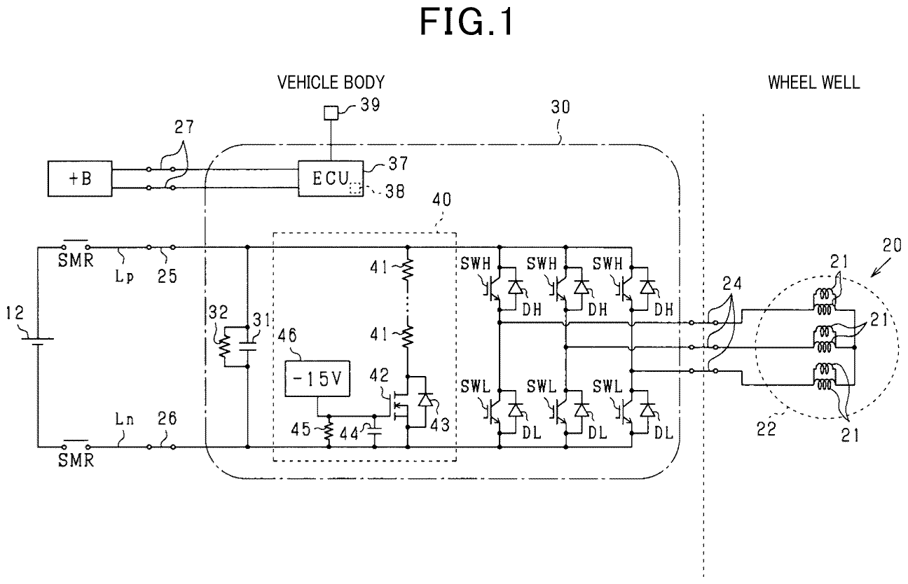

As illustrated in FIG. 1, a vehicle 10 includes a rotating electric machine 20 inside each wheel well. The rotating electric machine 20 is an in-wheel motor integrated with at least one wheel of the vehicle 10. The rotating electric machine 20 is a three-phase synchronous machine and includes stator windings 21 for respective phases that are star-connected. The stator windings 21 for the respective phases are disposed 120° apart in electrical angle from each other. The rotating electric machine 20 of the present embodiment is a permanent magnet synchronous machine with permanent magnets as field poles in the rotor 22.

The rotating electric machine 20 is a vehicle prime mover, in which the rotor 22 rotates in unison with the drive wheel of the vehicle 10. The torque generated by the rotating electric machine 20 functioning as an electric motor (during power running) and a generator (during regeneration) is transmitted from the rotor 22 to the drive wheel. The torque generated by the rotating electric machine 20 during power running causes the drive wheel to be driven to rotate.

The vehicle 10 includes an inverter 30, a low-voltage power source +B, and a rechargeable battery 12 that is a DC power source, in the vehicle body. The inverter 30 (as a drive circuit) includes a series connection of an upper-arm switch SWH (as an upper-arm switching element) and a lower-arm switch SWL (as a lower-arm switching element) for each of three phases. In the present embodiment, each of the switches SWH, SWL is a voltage-controlled semiconductor switching element, such an insulated gate bipolar transistor (IGBT). Thus, the high-side terminal of each of the switches SWH, SWL is the collector and the low-side terminal of each of the switches SWH, SWL is the emitter. Freewheel diodes DH, DL are connected in anti-parallel with the respective switches SWH, SWL.

For each phase, the emitter of the upper-arm switch SWH and the collector of the lower-arm switch SWL are connected to a first end of the stator winding 21 via the wiring 24. Second ends of the stator windings 21 for the respective phases are connected to each other at the neutral point. In the present embodiment, the stator winding 21 for each phase is set to have the same number of turns.

The collector of the upper-arm switch SWH for each phase is connected to the positive terminal of the rechargeable battery 12 by the positive-side bus Lp. The emitter of the lower-arm switch SWL for each phase is connected to the negative terminal of the rechargeable battery 12 by the negative-side bus Ln. The positive-side bus Lp and the negative-side bus Ln are connected by a smoothing capacitor 31. The smoothing capacitor 31 smooths the DC voltage applied from the rechargeable battery 12 to the switches SWH and SWL. A discharge resistor 32 is connected in parallel with the smoothing capacitor 31. When the smoothing capacitor 31 needs to be discharged, if the charge stored in the smoothing capacitor 31 is discharged only through the discharge resistor 32, it takes several minutes to lower the voltage of the smoothing capacitor 31 to 60 volts or lower. The smoothing capacitor 31 may be built in the inverter 30 or may be provided externally to the inverter 30.

System main relays SMR are provided between the rechargeable battery 12 and the inverter 30. The collector of the upper-arm switch SWH for each phase, the positive electrode of the smoothing capacitor 31, and the discharge resistor 32 are connected to the positive-side system main relay SMR through the wire 25. The emitter of the lower-arm switch SWL for each phase, the negative electrode of the smoothing capacitor 31, and the discharge resistor 32 are connected to the negative-side system main relay SMR through the wire 26.

The rechargeable battery 12 is, for example, an assembled battery, and the terminal voltage of the rechargeable battery 12 is, for example, several hundred volts. The rechargeable battery 12 is, for example, a secondary battery, such as a lithium-ion battery or a nickel-hydrogen battery.

The inverter 30 (in the vehicle 10) includes an ECU 37. The ECU 37 (as a control unit) is mainly configured as a microcomputer equipped with a CPU, a ROM, a RAM, an input/output interface, and the like. The ECU 37 is supplied with power from the low-voltage power source +B. The low-voltage power source +B and the ECU 37 are connected via wires 27. The ECU 37 receives, for example, a command torque Trq* from a higher-layer Electronic Control Unit (ECU). The command torque Trq* is positive during power running by the rotating electric machine 20, and the command torque Trq* is negative during regeneration (power generation) by the rotating electric machine 20. The ECU 37 controls switching of each of the switches SWH and SWL that constitute the inverter 30 in order to control the torque of the rotating electric machine 20 to the command torque Trq*.

A first acceleration sensor 38 is provided in the ECU 37. A second acceleration sensor 39 is also provided at the front of the vehicle. The acceleration sensors 38, 39 detect accelerations. Results of detection by the acceleration sensors 38, 39 are input to the CPU of the ECU 37 via the input/output interface.

The ECU 37 discharges the smoothing capacitor 31, for example, when a vehicle user parks the vehicle. In this case, the ECU 37 controls the switches SWH and SWL of the inverter 30 to pass the d-axis current Id (reactive current) through the stator windings 21 of the rotating electric machine 20 with the system main relays SMR being open (blocked). As a result, electrical energy stored in the smoothing capacitor 31 is consumed as heat in the rotating electric machine 20 in, for example, 0.5 to 1.0 seconds.

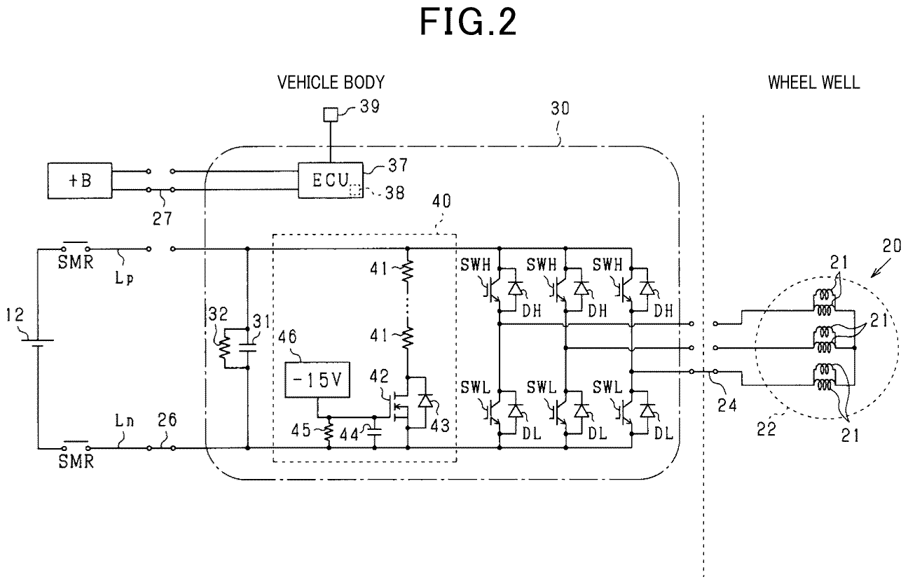

When the vehicle collides with an obstacle or the like, the wires 24, 25, 27 or the like may break, as illustrated in FIG. 2. In particular, the wires 24 connecting the rotating electric machine 20 disposed inside the wheel well and the inverter 30 are prone to breaking. When the wires 24 break, the d-axis current Id fails to be passed through the stator windings 21 of the rotating electric machine 20. When the wires 27 break, power is no longer supplied from the low-voltage power source +B to the ECU 37 and the ECU 37 becomes inoperable, so that the switches SWH and SWL of the inverter 30 fail to be controlled, and the d-axis current Id fails to be passed through the stator windings 21 of the rotating electric machine 20. Thus, discharging of smoothing capacitor 31 in a short time by passing the d-axis current Id through the stator windings 21 of the rotating electric machine 20 fails to be performed. In addition, when the drive wheel rotating in unison with the rotor 22 of the rotating electric machine 20 idles, an induced voltage of up to 600 volts may be generated.

Therefore, the inverter 30 includes a discharge circuit 40 for quickly discharging the smoothing capacitor 31. The wires connecting the smoothing capacitor 31 and the discharge circuit 40 are shorter than the wires connecting the smoothing capacitor 31 and the rotating electric machine 20, preferably shorter than the wires connecting the smoothing capacitor 31 and the switches SWH, SWL, so that the wires are less likely to break during vehicle collisions.

The discharge circuit 40 includes a plurality of resistive elements 41, a MOSFET 42, a diode 43, a capacitor 44, an adjustment resistive element 45, and a negative power source 46. The discharge circuit 40 discharges the smoothing capacitor 31 through the plurality of resistive elements 41 and the MOSFET 42.

The plurality of resistive elements 41 are connected in series with each other by wires. The MOSFET 42 is connected in series with the resistive elements 41.

The MOSFET 42 (as a transistor or a switching element) is a depletion-type N-channel transistor such that the drain current is maximized when no voltage is applied between the gate and the source and the drain current decreases to zero when a negative voltage is applied to the gate terminal. The MOSFET 42 has a drain current of zero when a voltage of −5 volts or lower is applied to the gate terminal. A diode 43 is connected in anti-parallel with the MOSFET 42. The heat resistance temperature of the MOSFET 42 is, for example, 150 degrees Celsius (° C.). Instead of the depletion-type N-channel MOSFET 42, another normally-on switching element may be used.

Between the gate and source terminals of the MOSFET 42, a capacitor 44 (passive element) and an adjustment resistive element 45 (passive element) are connected in parallel with each other. The capacitance of the capacitor 44 and the resistance of the adjustment resistive element 45 will be described later.

The negative power source 46 (as a voltage application unit) applies a voltage of −15 volts to the gate terminal of the MOSFET 42. When the voltage of −15 volts is applied to the gate terminal of the MOSFET 42 by the negative power source 46, the drain current of the MOSFET 42 becomes zero. The negative power source 46 is controlled by the ECU 37 and is switched between a state in which a voltage of −15 volts is being applied and a state in which application of −15 volts is suspended. When the ECU 37 becomes inoperable, the negative power source 46 ceases to apply −15 volts. The capacitor 44, the adjustment resistive element 45, and the negative power source 46 constitute an adjustment circuit.

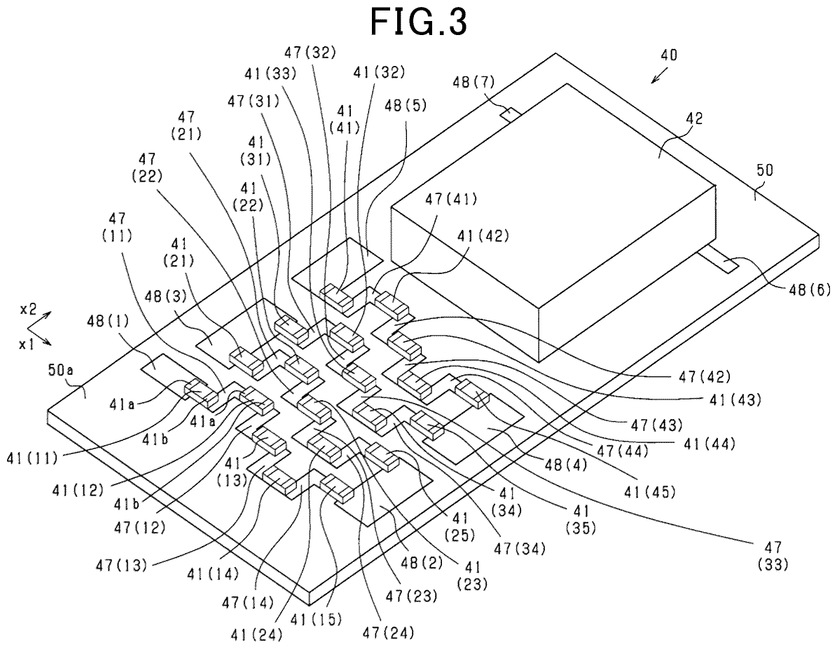

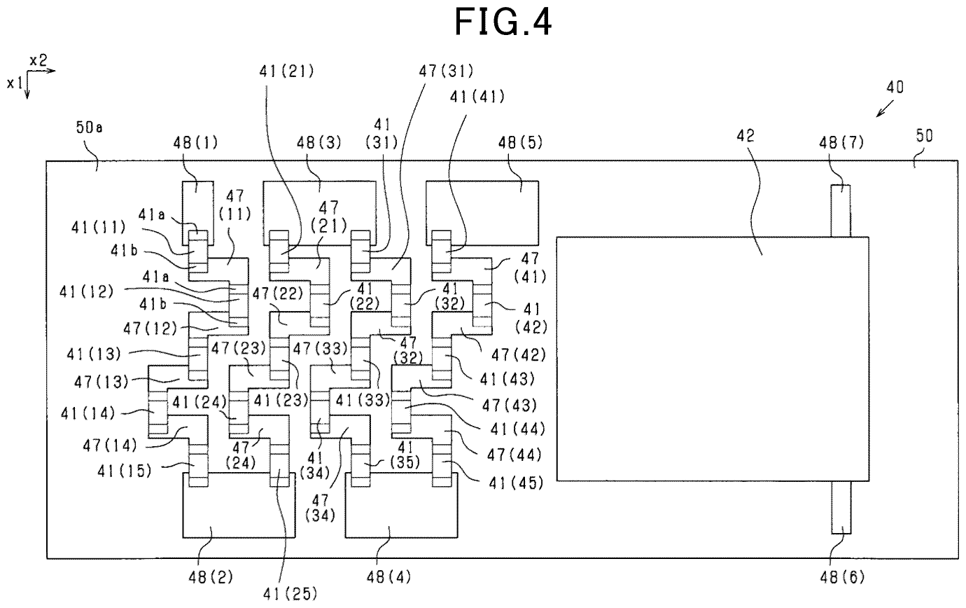

As illustrated in FIGS. 3 and 4, the discharge circuit 40 includes a rectangular-plate-shaped substrate 50. A plurality of resistive elements 41 (11-45) are mounted on the front side (first side) surface 50a of the substrate 50. The plurality of resistive elements 41 (11-45) are rectangular-plate-shaped chip resistors and include electrodes 41a and 41b at both ends in the longitudinal direction, spanning the length in the lateral direction.

The resistive elements 41(11), 41(12), 41(13), 41(14), 41(15) are connected in series by wires 47(11), 47(12), 47(13), 47(14), respectively. The electrodes 41b and 41a of the adjacent resistive elements 41 are connected by the wire 47. For example, the electrode 41b of the resistive element 41 (11) is connected to the electrode 41a of the resistive element 41 (12) by the wire 47 (11). The resistive elements 41(11), 41(12), 41(13), 41(14), 41(15), and the wires 47(11), 47(12), 47(13), 47(14) form a first series connection.

Similarly, the resistive elements 41(21), 41(22), 41(23), 41(24), 41(25), and the wires 47(21), 47(22), 47(23), 47(24) form a second series connection. The resistive elements 41(31), 41(32), 41(33), 41(34), 41(35), and the wires 47(31), 47(32), 47((33), 47((34)) form a third series connection. The resistive elements 41 (41), 41 (42), 41 (43), 41 (44), 41 (45), and the wires 47 (41), 47 (42), 47 (43), 47 (44) form a fourth series connection.

The first series connection and the second series connection are connected in series by the wire 48 (2). The second series connection and the third series connection are connected in series by the wire 48(3). The third series connection and the fourth series connection are connected in series by the wire 48(4). The wire 48(1) is connected to the positive-side bus Lp.

Since the resistive elements 41 are connected in series by the wires 47, the heat generated in the resistive elements 41 is conducted to each other through the wires 47. Thus, a large amount of heat conducted to each other through the wires 47 results in poor heat dissipation, and the temperature of each resistive element 41 is liable to rise. In particular, the resistive elements 41 are chip resistors. Since the chip resistors are smaller in volume and have smaller thermal capacitance than common resistive elements, the temperature of the chip resistors is liable to rise due to heat generation. Furthermore, each of the resistive elements 41 includes the electrodes 41a and 41b at both ends in the first direction X1, spanning the length in the second direction X2. Thus, the heat generated in the resistive elements 41 is likely to be conducted from the electrodes 41a, 41b spanning the length in the second direction X2 to each other through the wires 47.

Therefore, the resistive elements 41 (11), 41 (12), 41 (13), 41 (14), 41 (15) are disposed at intervals in the first direction X1 parallel to the shorter side of the substrate 50. The resistive elements 41 adjacent to each other in the first direction X1 and included in the same series connection are displaced from each other in the second direction X2 (parallel to the longer side of the substrate 50), which is perpendicular to the first direction X1. That is, the positions of the resistive elements 41 adjacent in the first direction X1 and included in the same series connection are different from each other in the second direction X2. Specifically, there is no overlap range in the second direction X2 where the resistive elements 41 adjacent to each other in the first direction X1 and included in the same series connection overlap positionally in the second direction X2 (less than half the length of each resistive element 41 in the second direction X2). For example, there is no overlap range in the second direction X2 where the resistive elements 41 (11) and 41 (12) overlap positionally in the second direction X2.

Furthermore, there is no overlap range in the second direction X2 where the electrodes 41a, 41b of the resistive elements 41 adjacent to each other in the first direction X1 and included in the same series connection overlap positionally in the second direction X2 (less than half the length of each resistive element 41 in the second direction X2). For example, there is no overlap range in the second direction X2 where the electrode 41b of the resistive element 41 (11) and the electrode 41a of the resistive element 41 (12), connected to each other by the wire 47(11), overlap positionally in the second direction X2.

As to the resistive elements 41 (11-15) included in the same series connection, the positions of the first, third, and fifth resistive elements 41 (11, 13, 15) in the second direction X2 are equal, the position of the second resistive element 41 (12) is displaced in the second direction X2, and the position of the fourth resistive element 41 (14) is displaced in the opposite direction (−X2 direction) from the second direction X2. That is, in the entire series connection, the resistive elements 41 are sinusoidally displaced in the second direction X2. The first series connection has been described above as an example, but the same is true for the second through fourth series connections.

When the plurality of resistive elements 41 connected in series by wires 47 are aligned in the first direction X1, the resistive element 41 that is more centrally positioned in the first direction X1 is more prone to heat concentration and it is harder to dissipate heat therefrom. Therefore, the resistance values of the resistive elements 41 in the series connection are set as follows: the resistance values of the first and fifth resistive elements 41 (11, 15) are higher, the resistance value of the third resistive element 41 (13) is lower, and the resistance values of the second and fourth resistive elements 41 (12, 14) are lower than the resistance values of the first and fifth resistive elements 41 (11, 15) and higher than the resistance value of the third resistive element 41 (13). That is, the resistive element positioned more centrally in the first direction X1, included in any of the series connections, has a lower resistance value. The first series connection has been described as an example, but the same is true for the second through fourth series connections.

As illustrated in FIG. 5, a plurality of resistive elements 41 are also mounted on the back side (second side) surface 50b of the substrate 50. On the back side surface 50b of the substrate 50, as with the first through fourth series connections, a plurality of series connections extending in the first direction X1 are disposed side by side in the second direction X2. On the back side surface 50b of the substrate 50, the plurality of series connections are connected in series with each other by wires.

The wire 48(5) illustrated in FIGS. 3 and 4 is connected to the first series connection on the back side surface 50b of the substrate 50 via a via hole (conduction hole) provided in the substrate 50. The last series connection on the back side surface 50b of the substrate 50 is connected to the drain terminal of the above MOSFET 42 mounted on the front side surface 50a of the substrate 50 via the via hole (conduction hole) provided in the substrate 50 and a wire 48 (6). The source terminal of the MOSFET 42 is connected to the negative-side bus Ln through the wire 48 (7).

In the projection onto the front side surface 50a, the resistive elements 41 mounted on the front side surface 50a and the resistive elements 41 mounted on the back side surface 50b do not overlap each other at all. That is, in the projection onto the front side surface 50a, the area of overlap between the resistive elements 41 mounted on the front side surface 50a and the resistive elements 41 mounted on the back side surface 50b is zero (less than half the area of the resistive elements 41).

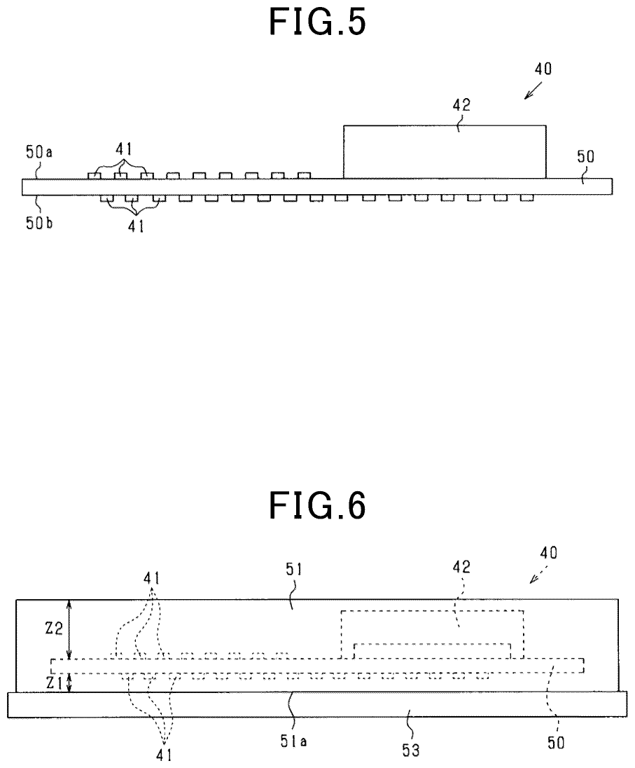

As illustrated in FIG. 6, the discharge circuit 40 is encapsulated with a resin 51. That is, the resistive elements 41 and the MOSFET 42 are encapsulated with the resin 51 to be integrated into the substrate 50. The thermal conductivity of the resin 51 is 0.6 W/mK (0.6 W/mK or higher). The thermal conductivity of common epoxy resin is 0.3 W/mK and the thermal conductivity of air is 0.026 W/mK. The overall shape of the resin 51 is rectangular (plate-shaped). The resin 51 has a flat surface portion 51a.

A cooler 53 is attached to (in contact with) the flat surface portion 51a of the resin 51. The cooler 53 (cooling member) is formed of metal or the like, and has a flow path of cooling water inside. The cooler 53 cools the resin 51, and thus the substrate 50, the resistive elements 41, and the MOSFET 42, by circulating cooling water inside. The thickness Z1 of the resin 51 on the cooler 53 side of the substrate 50 is thinner than the thickness Z2 of the resin 51 on the opposite side of the substrate 50 from the cooler 53.

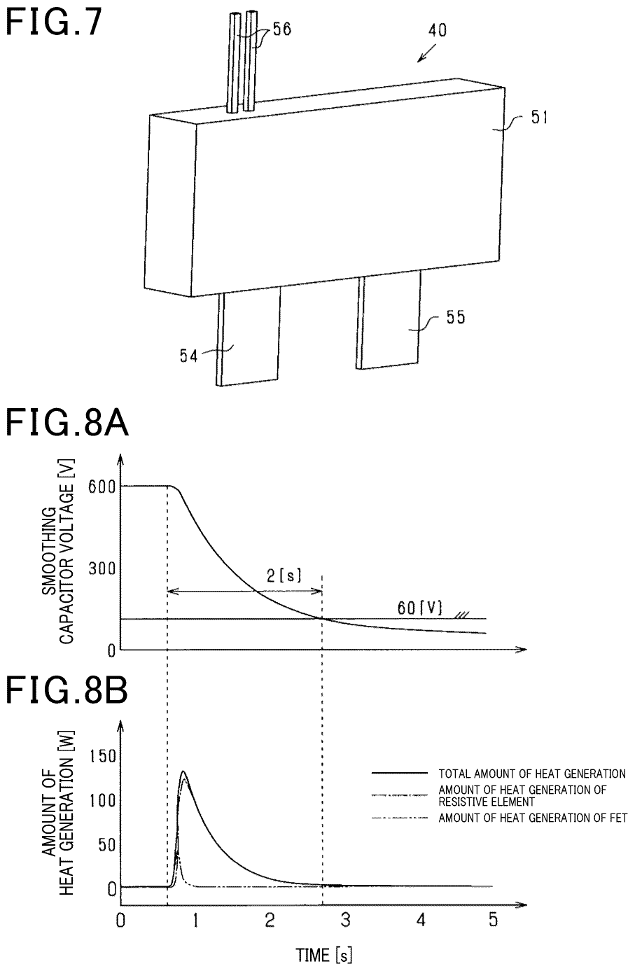

As illustrated in FIG. 7, bus-bars 54, 55 and lead frames 56 extend from the discharge circuit 40 encapsulated with the resin 51 to the outside the resin 51. The bus-bars 54, 55 are formed in a plate shape using a copper alloy or the like. The lead frames 56 are formed in the form of a rod using a copper alloy or the like. The bus-bar 54 (wire) is connected at one end to the wire 48(1) of the discharge circuit 40 inside the resin 51, and is connected at the other end to the positive-side bus Lp (positive electrode of the smoothing capacitor 31) outside the resin 51. The bus-bar 55 (wire) is connected to the wire 48(7) of the discharge circuit 40 at one end inside the resin 51 and is connected to the negative-side bus Ln (negative electrode of the smoothing capacitor 31) at the other end outside the resin 51. Each lead frame 56 (wire for controlling energization of the resistive elements 41) is connected to the negative power source 46 of the discharge circuit 40 at one end inside the resin 51, and is connected to the ECU 37 at the other end outside the resin 51.

FIG. 8A is a graph of target voltage of the smoothing capacitor 31 versus time. FIG. 8B is a graph of amount of heat generation by each element versus time.

As illustrated in FIG. 8A, in the present embodiment, the voltage of the smoothing capacitor 31 is intended to decrease to 60 volts or lower within 2 seconds from the beginning of discharge. Then, the temperature of the resistive elements 41 needs to be kept at or below the heat resistance temperature. The heat resistance temperature of the resistive elements 41 varies according to whether they themselves generate heat, etc. For example, the heat resistance temperature is 145 degrees Celsius.

To decrease the amount of heat generation by the resistive elements 41, the MOSFET 42 is turned half on (placed in a high on-resistance state) at the initial stage of discharge of the smoothing capacitor 31, and the electrical energy of the smoothing capacitor 31 is thereby consumed by the MOSFET 42. As illustrated in FIG. 8B, this causes the MOSFET 42 to share part of amount of heat generation during the period when the voltage of the smoothing capacitor 31 is still high and the amount of heat generation during discharge is still high. As a result, the amount of heat generation by the resistive elements 41 is decreased and the temperature rise of the resistive elements 41 is thereby suppressed.

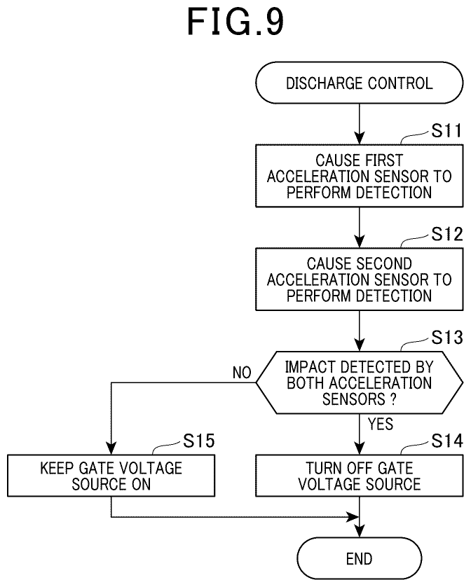

FIG. 9 is a flowchart of a discharge control process. This series of process steps are performed repeatedly by the ECU 37 at predefined time intervals.

First, the ECU 37 causes the first acceleration sensor 38 to detect the acceleration (Step S11). The ECU 37 causes the second acceleration sensor 39 to detect the acceleration (Step S12). The order of steps S11 and S12 may be reversed.

Subsequently, the ECU 37 determines whether an impact has been detected by both the first acceleration sensor 38 and the second acceleration sensor 39 (S13). Specifically, the ECU 37 determines whether the acceleration detected by the first acceleration sensor 38 and the acceleration detected by the second acceleration sensor 39 are both higher than a predefined acceleration A. The predefined acceleration A is an acceleration at which the vehicle may be determined to have collided with an obstacle or the like.

If the ECU 37 determines at S13 that an impact has been detected by both the first acceleration sensor 38 and the second acceleration sensor 39 (Step S13: YES), the ECU 37 turns off the negative power source 46 (gate voltage source) (Step S14). This ceases application of the voltage of −15 volts to the gate terminal of the MOSFET 42 by the negative power source 46. Thus, the capacitor 44 is gradually discharged through the adjustment resistive element 45, and the gate voltage of the MOSFET 42 gradually rises (the voltage applied to the gate terminal of MOSFET 42 is adjusted). Therefore, the MOSFET 42 is turned and kept half on for a predefined time and then turned fully on, and the smoothing capacitor 31 is discharged through the plurality of resistive elements 41 and the MOSFET 42 connected in series. That is, fast discharge by the discharge circuit 40 is performed. Thereafter, the ECU 37 terminates this series of process steps (END). On the other hand, if the ECU 37 determines at S13 that no impact has been detected by at least one of the first acceleration sensor 38 and the second acceleration sensor 39 (Step S13: NO), the ECU 37 terminates this sequence of process steps (END). That is, the ECU 37 does not perform fast discharge by the discharge circuit 40.

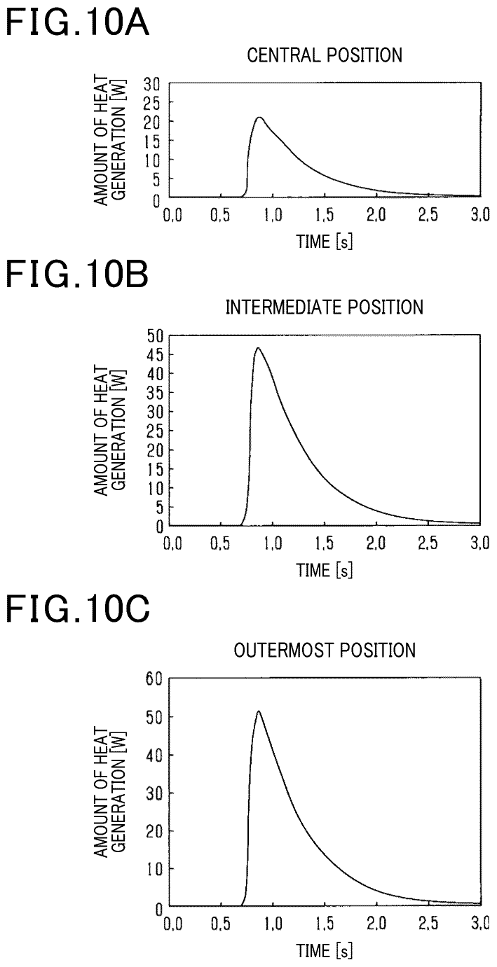

FIGS. 10A-10C are graphs of amounts of heat generated by the resistive elements at different positions versus time during fast discharge by the discharge circuit 40. The resistance value of the resistive element 41 in a central position is set to a lower value. The resistance value of the resistive element 41 in an outermost position is set to a higher value. Therefore, the resistive element 41 in the central position generates the smallest amount of heat, the resistive element 41 in the outermost position generates the largest amount of heat, and the resistive element 41 in a position between the central position and the outermost position generates an intermediate amount of heat between the smallest and largest amounts of heat.

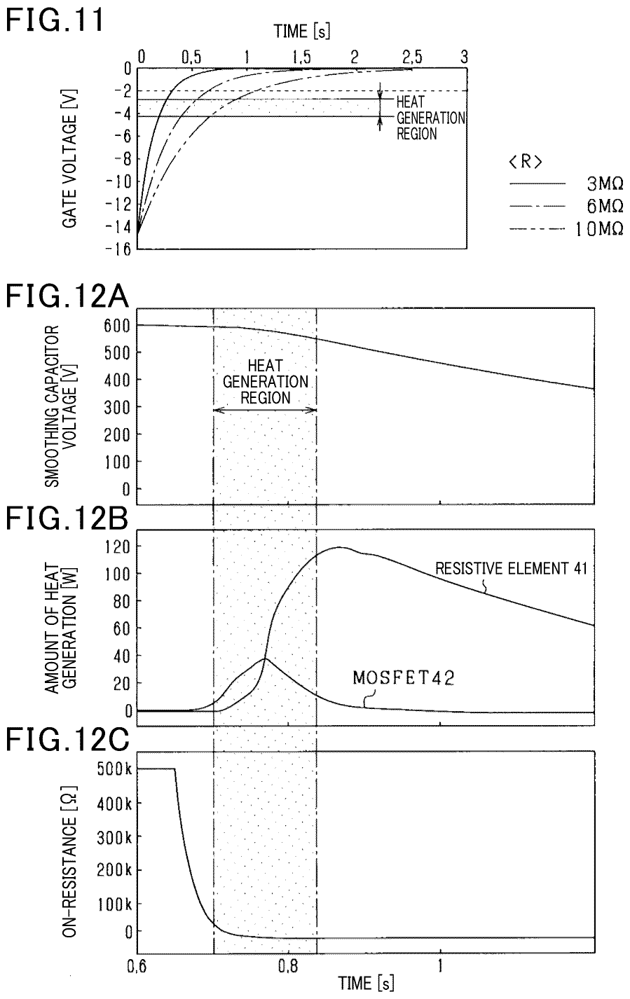

FIG. 11 is a graph of a relationship between resistance value of the adjustment resistive element 45 and gate voltage of the MOSFET 42. When the resistance value of the adjustment resistive element 45 is changed, the gate voltage rises at a different rate during suspension of application of the negative voltage from the negative power source 46 to the gate terminal of the MOSFET 42. It has been confirmed by simulation and other means that when the gate voltage of the MOSFET 42 is between −4.25 and −2.75 volts (heat generation region), the MOSFET 42 generates a larger amount of heat. When the resistance value of the adjustment resistive element 45 is 10 M ohms, the gate voltage remains in the heat generation region for the longest time, and the gate voltage reaches substantially zero by 2 seconds. Therefore, the resistance value of the adjustment resistive element 45 is set to 10 M ohms in the present embodiment. The capacitance of the capacitor 44 is set to a predefined capacitance according to the characteristics of the MOSFET 42 and the resistance value of the adjustment resistive element 45.

FIG. 12A is a graph of voltage of the smoothing capacitor 31 versus time during fast discharge by the discharge circuit 40. FIG. 12B is graphs of amounts of heat generated by the resistive elements 41 and the MOSFET 42 versus time during fast discharge by the discharge circuit 40. FIG. 12C is a graph of on-resistance of the MOSFET 42 versus time during fast discharge by the discharge circuit 40. Referring to FIG. 11, in a heat generation region where the gate voltage of the MOSFET 42 is within a range of −4.25 to −2.75 volts, the on-resistance of the MOSFET 42 is within a range of 20 k to 400 ohms. As illustrated in FIG. 12B, the heat generation region includes a peak of the amount of heat generation by the MOSFET 42. When the smoothing capacitor 31 is discharged through the resistive elements 41 and the MOSFET 42, the amount of instantaneous heat generation by the MOSFET 42 increases more rapidly than the amount of instantaneous heat generation by the resistive elements 41. This makes the MOSFET 42 share part of amount of heat generated during the period when the voltage of the smoothing capacitor 31 is still high and the amount of heat generation by the discharge is large. When the smoothing capacitor 31 is discharged through the resistive elements 41 and the MOSFET 42, the peak amount of instantaneous heat generation by the MOSFET 42 occurs before the peak amount of instantaneous heat generation by the resistive elements 41. The shapes of graphs of amounts of heat generated by the resistive elements 41 and the MOSFET 42 may be changed by adjusting the heat capacities of the resistive elements 41 and the MOSFET 42.

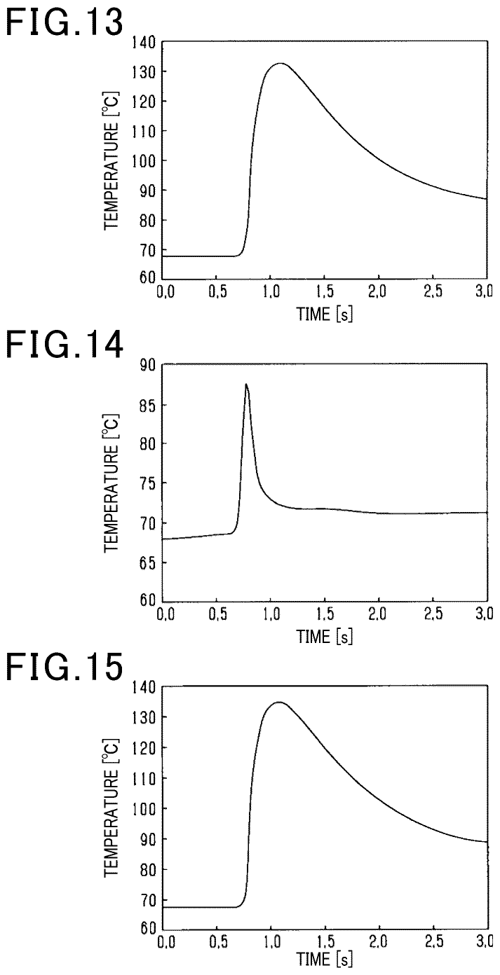

FIG. 13 is a graph of the temperature of the resistive element 41 that has the highest temperature in the present embodiment. In the present embodiment, the fourth resistive element 41 (34) in the third series connection has the highest temperature. The peak temperature of the resistive elements 41 (34) is about 132 degrees Celsius, which is lower than or equal to the heat resistance temperature of 145 degrees Celsius.

FIG. 14 is a graph of the temperature of the MOSFET 42 in the present embodiment. The peak temperature of the MOSFET 42 occurs earlier than the peak temperature of the resistive element 41 (34) illustrated in FIG. 13. The peak temperature of the MOSFET 42 is about 88 degrees Celsius, which is lower than or equal to the heat resistance temperature of 150 degrees Celsius.

FIG. 15 is a graph of the temperature of the resistive element 41 that has the highest temperature in a first example modification. The first example modification differs from the present embodiment only in that the resistance values of the resistive elements 41 are the same. That is, the first example modification is not configured such that the resistive element positioned more centrally in the first direction X1 has a lower resistance value. In the first example modification, the third resistive element 41 (33) in the third series connection has the highest temperature. The peak temperature of the resistive element 41 (33) is about 136 degrees Celsius, which is lower than or equal to the heat resistance temperature of 145 degrees Celsius.

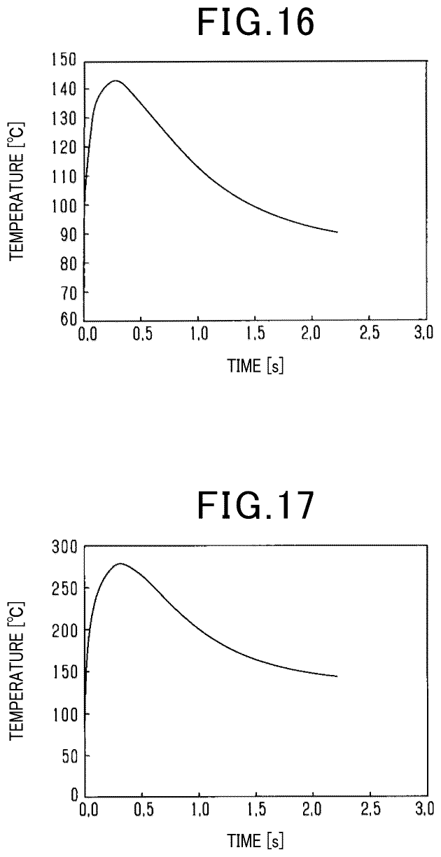

FIG. 16 is a graph of the temperature of the resistive element 41 having the highest temperature in a second example modification. The second example modification differs from the present embodiment in that the resistance values of the resistive elements 41 are the same and the MOSFET 42 is turned fully on immediately without being turned half on. That is, the second example modification is not configured such that the resistive element positioned more centrally in the first direction X1 has a lower resistance value. In the second example modification, the third resistive element 41 (33) in the third series connection has the highest temperature. The peak temperature of the resistive element 41 (33) is about 144 degrees Celsius, which is lower than or equal to the heat resistance temperature of 145 degrees Celsius.

FIG. 17 is a graph of the temperature of the resistive element 41 that has the highest temperature in a third example modification. The third example modification differs from the present embodiment in that the resistance values of the resistive elements 41 are the same, the MOSFET 42 is turned fully on immediately without being turned half on, the resistive elements 41 are not encapsulated with the resin 51, and the cooler 53 is omitted. That is, the third example modification is not configured such that the resistive element positioned more centrally in the first direction X1 has a lower resistance value. In the third example modification, the resistive element 41 disposed in the central position on the back side surface 50b of the substrate 50 has the highest temperature. The peak temperature of this resistive element 41 is about 280 degrees Celsius, which exceeds the heat resistance temperature of 145 degrees Celsius.

The present embodiment described in detail above can provide the following advantages.

(1) The discharge circuit 40 includes a series connection of at least three resistive elements 41 spaced apart from each other in the first direction X1 and connected in series by wires 47. When a plurality of resistive elements 41 connected in series by wires 47 are aligned in the first direction X1, the resistive element 41 in a more central position in the first direction X1 has heat more concentrated and it is harder to dissipate heat therefrom. In this respect, the resistive element 41 positioned more centrally in the first direction X1, included in the series connection, has a lower resistance value. This can decrease an amount of heat generation by the resistive element 41 positioned more centrally in the first direction X1, thereby suppressing the temperature of the resistive element 41 from which it is harder to dissipate heat, to prevent it from exceeding a heat resistance temperature.

(2) Since the resistive elements 41 are connected in series by the wires 47, heat generated in the resistive elements 41 is conducted to each other through the wires 47. Thus, in a case where there is a large amount of heat conducted to each other through the wires 47, it becomes harder to dissipate heat from the resistive elements 41, and the temperature of each resistive element 41 is liable to rise. In this regard, an overlap range in a second direction X2 perpendicular to the first direction X1 where the resistive elements 41 adjacent to each other in the first direction X1 and included in the same series connection overlap positionally in the second direction X2 is less than half the length of each resistive element 41 in the second direction X2. Thus, the wires 47 connecting the adjacent resistive elements 41 in the first direction X1 can be elongated or made longer, and the heat generated in the resistive elements 41 can be suppressed from being conducted to each other through the wires 47. This can facilitate dissipating the heat generated in the resistive elements 41, thereby suppressing a rise in the temperature of each resistive element 41.

(3) The above two advantages allow the smoothing capacitor 31 to be discharged in a shorter time and also facilitate keeping the temperature of each resistive element 41 at or below the heat resistance temperature.

(4) Each resistive element 41 is a chip resistor. Chip resistors are smaller in volume and have a smaller thermal capacity than common resistive elements 41, so the temperature of each chip resistor is liable to rise due to heat generation. Furthermore, each resistive element 41 includes electrodes 41a and 41b at both ends in the first direction X1, where the electrodes 41a and 41b extend over the length of the resistive element 41 in the second direction X2. Thus, the heat generated in resistive elements 41 becomes more conductive from the electrodes 41a, 41b over the length in the second direction X2 to each other through the wires 47. In this regard, an overlap range in the second direction X2 where the electrodes 41a, 41b, each belonging to a different one of the resistive elements 41 adjacent to each other in the first direction X1 and included in the same series connection, overlap positionally in the second direction X2 is less than half the length of each resistive element 41 in the second direction X2. Therefore, the wires 47 connecting the electrodes 41a, 41b of the resistive elements 41, adjacent in the first direction X1, can be elongated or made longer, and the heat generated in the resistive elements 41 can be suppressed from being conducted from the electrodes 41a, 41b to each other through the wires 47.

(5) An overlap range in the second direction X2 where the electrodes 41a, 41b, each belonging to a different one of the resistive elements 41 adjacent to each other in the first direction X1 and included in the same series connection, overlap positionally in the second direction X2 does not exist. Such a configuration allows the wires 47 connecting the electrodes 41a, 41b of the resistive elements 41, adjacent in the first direction X1, to be further elongated or made longer, thereby suppressing the heat generated in the resistive elements 41 from being conducted from the electrodes 41a, 41b to each other through the wires 47. That is, in the discharge circuit 40 where a plurality of resistive elements 41 need to be arranged efficiently, heat dissipation from the resistive elements 41 can be improved by elongating the wires 47 connecting the adjacent resistive elements 41 in the first direction X1.

(6) A plurality of resistive elements 41 are mounted on each of the front side surface 50a and the back side surface 50b of the substrate 50. In the projection onto the front side surface 50a, the area of overlap between each of the resistive elements 41 mounted on the front side surface 50a and each of the resistive elements 41 mounted on the back side surface 50b is less than half the area of each of the plurality of resistive elements 41. In the discharge circuit 40 including a plurality of resistive elements 41 mounted on the front side surface 50a of the substrate 50 and a plurality of resistive elements 41 mounted on the back side 50b of the substrate 50, the above configuration can decrease the area of overlap between each of the resistive elements 41 mounted on the front side surface 50a of the substrate 50 and each of the resistive elements 41 mounted on the back side surface 50b of the substrate 50 in the projection onto the front side surface 50a. Therefore, an amount of heat conducted between the resistive elements 41 mounted on the front side surface 50a and the resistive elements 41 mounted on the back side surface 50b can be decreased, thereby improving the heat dissipation from each resistive element 41.

(7) The resistive elements 41 are encapsulated with the resin 51 and thereby integrated into the substrate 50. Such a configuration allows the heat generated in the resistive elements 41 to be conducted to the resin 51, and further allows the heat to be conducted from the resin 51 to the substrate 50. Therefore, this can suppress a rise in the temperature of each resistive element 41.

(8) The resin 51 has a flat surface portion 51a, and the cooler 53, which has a temperature lower than the temperature of the resin 51, is in contact with the flat surface portion 51a. Such a configuration allows the resin 51 encapsulating the resistive elements 41 to be cooled by the cooler 53, thereby further suppressing a rise in the temperature of each resistive element 41.

(9) The resin 51 is provided on both sides of the substrate 50, and the thickness Z1 of the resin 51 on the cooler 53 side of the substrate 50 is thinner than the thickness Z2 of the resin 51 on the opposite side of the substrate 50 from the cooler 53. Such a configuration allows the heat generated to be efficiently conducted from the resistive elements 41 to cooler 53 through the thinner resin 51 on the cooler 53 side of the substrate 50. Furthermore, the thicker resin 51 on the opposite side of the substrate 50 from the cooler 53 can increase the heat capacity of the resin 51, thereby suppressing a rise in the temperature of each resistive element 41.

(10) The thermal conductivity of the resin 51 is 0.6 W/mK or higher. Such a configuration allows heat conduction from the resistive elements 41 to the resin 51 to be promoted, and can further suppress a rise in the temperature of each resistive element 41.

(11) The bus-bars 54 and 55, which are connected to both ends of the smoothing capacitor 31 respectively, and the lead frames 56, which control current conduction to the resistive elements 41, extend from the substrate 50 to the outside the resin 51. Such a configuration facilitates connecting the wires 47 from the outside to the discharge circuit 40 in a configuration where the resistive elements 41 are encapsulated with the resin 51 to be integrated into the substrate 50.

(12) When the smoothing capacitor 31 is discharged through the resistive elements 41 and the MOSFET 42, the adjustment circuit adjusts the voltage applied to the gate terminal of the MOSFET 42 to turn and keep the MOSFET 42 half on for a predefined time and then turn the MOSFET 42 fully on. Thus, turning and keeping the MOSFET 42 half on for a predefined time allows the MOSFET 42 to actively generate heat, thereby decreasing the amount of heat generation by the resistive elements 41. Then, after the electrical energy of the smoothing capacitor 31 is consumed to some extent, the MOSFET 42 is turned fully on, and the remaining electrical energy of the smoothing capacitor 31 is thereby consumed by the resistive elements 41. This allows the smoothing capacitor 31 to be discharged in a shorter time and also facilitates keeping the temperature of each resistive element 41 at or below the heat resistance temperature.

(13) When the smoothing capacitor 31 is discharged through the resistive elements 41 and the MOSFET 42, the amount of instantaneous heat generation by the MOSFET 42 increases more rapidly than the amount of instantaneous heat generation by the resistive elements 41. According to such a configuration, causing the MOSFET 42 to heat up first can decrease the amount of heat generation by the resistive elements 41. This can therefore lower the maximum temperature of the resistive elements 41, thereby facilitating keeping the temperature of each resistive element 41 at or below the heat resistance temperature.

(14) When the smoothing capacitor 31 is discharged through the resistive elements 41 and the MOSFET 42, the peak amount of instantaneous heat generation by the MOSFET 42 occurs earlier than the peak amount of instantaneous heat generation by each resistive element 41. Such a configuration allows the time when the amount of heat generation by the MOSFET 42 peaks to precede the time when the amount of heat generation by each resistive element 41 peaks. This allows the maximum temperature of the resistive elements 41 to be lowered, which facilitates keeping the temperature of each resistive element 41 at or below the heat resistance temperature.

(15) The MOSFET 42 is a depletion type transistor, and the adjustment circuit includes the negative power source 46, which applies a negative voltage to the gate terminal of the MOSFET 42, the adjustment resistive element 45 (passive element) and the capacitor 44 (passive element) connected in parallel with each other between the gate and source terminals of the MOSFET 42. According to such a configuration, when application of the negative voltage to the gate terminal of MOSFET 42 by the negative power source 46 is suspended, the voltage applied to the gate terminal of MOSFET 42 is adjusted by the adjustment resistive elements 45 and the capacitor 44 to turn and keep the MOSFET 42 half on for a predefined time and then turn the MOSFET 42 fully on. Furthermore, even if application of the negative voltage to the gate terminal of MOSFET 42 by the negative power source 46 is unintentionally suspended, the same advantages can be achieved.

(16) When the acceleration detected by each of the acceleration sensors 38, 39 is higher than the predefined acceleration A, for example, when the vehicle carrying the discharge circuit 40 experiences a collision, the ECU 37 suspends application of the negative voltage by the negative power source 46. Thus, the voltage applied to the gate terminal of the MOSFET 42 is adjusted by the adjustment resistive element 45 and the capacitor 44, thereby allowing the MOSFET 42 to be turned and kept half on for a predefined time and then turned fully on.

The present disclosure is not limited to the above embodiment. Accordingly, changes can be made to the above embodiment as appropriate. Representative examples of modifications are described below. In the following description of the example modifications, differences from the above embodiment will mainly be described. In addition, the same number is attached to parts that are identical or equal to each other in the above embodiment and the example modifications. Therefore, in the following description of the example modifications, the description in the above embodiment may be used as appropriate for the constituent elements having the same numbers as in the above embodiment, unless there is any technical contradiction or special additional explanation.

(17) The thickness Z1 of the resin 51 on the cooler 53 side of the substrate 50 may be equal to the thickness Z2 of the resin 51 on the opposite side of the substrate 50 from the cooler 53.

(18) A common epoxy resin or the like may be employed as the resin 51.

(19) The entire substrate 50 may not be encapsulated with resin 51, but only the resistive elements 41 or only the resistive elements 41 and the MOSFET 42 may be encapsulated with the resin 51. As an alternative, the resin 51 may be omitted. As another alternative, the cooler 53 may be omitted.

(20) A coil may be included as a passive element connected in parallel with the gate and source terminals of the MOSFET 42.

(21) When the smoothing capacitor 31 is discharged through the resistive elements 41 and the MOSFET 42, the peak amount of instantaneous heat generation by the MOSFET 42 and the peak amount of instantaneous heat generation by the resistive elements 41 may occur at the same time.

(22) When the smoothing capacitor 31 is discharged through the resistive elements 41 and the MOSFET 42, the amount of instantaneous heat generation by the MOSFET 42 and the amount of instantaneous heat generation by the resistive elements 41 may increase simultaneously.

(23) Of the resistive elements 41 (11-15) included in the same series connection, the first, third, and fifth resistive elements 41 (11, 13, 15) may have the same position in the second direction X2, and the second and fourth resistive elements 41 (12, 14) may be displaced in the second direction X2. That is, in the entire series connection, the resistive elements 41 may be positioned in a half-wave form (staggered) in the second direction X2.

(24) The larger the resistive elements 41 are, the larger the portion of the resistive elements 41 in contact with the wires 47 and the substrate 50 can be made, which facilitates heat dissipation from the resistive elements 41 to the wires 47 and the substrate 50. Therefore, the size of each resistive element 41 included in the series connection may be set larger as the resistive element 41 is more centrally positioned in the first direction X1. Such a configuration can facilitate heat dissipation from the resistive element 41 positioned more centrally, from which it is harder to dissipate heat, to the wires 47 and the substrate 50, thereby suppressing the temperature of the resistive element 41 positioned centrally from exceeding the heat resistance temperature. Common resistive elements may be employed as the resistive elements 41, instead of chip resistors.

(25) In the projection onto the front side surface 50a of the substrate 50, the area of overlap between each of the resistive elements 41 mounted on the front side surface 50a and each of the resistive elements 41 mounted on the back side surface 50b may be greater than or equal to half the area of each resistive element 41. The resistive elements 41 may be mounted only on the front side surface 50a of the substrate 50. The discharge circuit 40 may be distributed over a plurality of substrates and integrated together by the resin 51.

(26) The resistive elements 41 may be disposed only on the outer edge of the front side surface 50a of the substrate 50, rather than on the entire front side surface 50a of the substrate 50. In a case where the series connection extends inward from the outer edge of the front side surface 50a of the substrate 50, the resistance value of the resistive element 41 included in the series connection and positioned more centrally in the series connection extending inward from the outer edge of the substrate 50 may be set to a smaller value. As an alternative, in a case where the series connection extends along the outer edge of the front side surface 50a of the substrate 50, the resistance value of the resistive element 41 included in the series connection and positioned more centrally in the series connection extending along the outer edge of the substrate 50 may be set to a smaller value.

(27) A determination may be made as to whether the vehicle has collided with an obstacle or the like based on results of detection by a yaw-rate sensor or the like mounted to the vehicle body or wheel, instead of the acceleration sensors 38, 39. The acceleration sensors 38, 39 may be omitted and the ECU 37 may not perform discharge control. Even in such a case, if the vehicle collides with an obstacle or the like and the negative power source 46 becomes off, fast discharge by the discharge circuit 40 may be automatically performed.

(28) The adjustment circuit may include a voltage adjustment unit (variable setting unit) that adjusts (variably sets) the negative voltage applied to the gate terminal of the MOSFET 42, instead of the adjustment resistive element 45, the capacitor 44, and the negative power source 46. According to such a configuration, the voltage adjustment unit adjusting the negative voltage applied to the gate terminal of MOSFET 42 may allow the MOSFET 42 to be turned and kept half on for a predefined time and then turned fully on. Instead of the depletion-type N-channel MOSFET 42, a depletion-type P-channel MOSFET, an enhancement-type N-channel MOSFET, an enhancement-type P-channel MOSFET, or the like may be employed.

Although the present disclosure has been described in accordance with the above-described embodiments, it is not limited to such embodiments, but also encompasses various variations and variations within equal scope. In addition, various combinations and forms, as well as other combinations and forms, including only one element, more or less, thereof, are also within the scope and idea of the present disclosure.

What is claimed is:

1. A discharge circuit for discharging a smoothing capacitor that smooths a DC voltage through a plurality of resistive elements mounted on a substrate, comprising:
a series connection of at least three resistive elements spaced apart from each other in a first direction and connected in series by wires, wherein
the resistive element positioned more centrally in the first direction, included in the series connection, has a lower resistance value, and
the resistive elements adjacent to each other in the first direction and included in the series connection are displaced from each other in a second direction perpendicular to the first direction.

2. The discharge circuit according to claim 1, wherein
an overlap range in the second direction perpendicular to the first direction where the resistive elements adjacent to each other in the first direction and included in the series connection overlap positionally in the second direction is less than half a length of each resistive element in the second direction.

3. The discharge circuit according to claim 1, wherein
each of the plurality of resistive elements is a chip resistor,
each of the plurality of resistive elements comprises electrodes at both ends in the first direction, each of the electrodes extending over a length of the resistive element in the second direction, wherein
an overlap range in the second direction where the electrodes, each belonging to a different one of the resistive elements adjacent to each other in the first direction and included in the series connection, overlap positionally in the second direction is less than half the length of each resistive element in the second direction.

4. The discharge circuit according to claim 1, wherein
there is no overlap range in the second direction where the resistive elements adjacent to each other in the first direction and included in the series connection overlap positionally in the second direction.

5. The discharge circuit according to claim 1, wherein
a plurality of the resistive elements are mounted on each of a front side surface and a back side surface of the substrate, and
in a projection onto the front side surface of the substrate, an area of overlap between each of the resistive elements mounted on the front side surface and each of the resistive elements mounted on the back side surface is less than half an area of each of the plurality of resistive elements.

6. The discharge circuit according to claim 1, wherein
a size of each resistive element included in the series connection is set larger as the resistive element is more centrally positioned in the first direction.

7. The discharge circuit according to claim 1, wherein
the plurality of resistive elements are encapsulated with a resin and thereby integrated into the substrate.

8. The discharge circuit according to claim 7, wherein
the resin has a flat surface portion formed, and a cooling member, which has a temperature lower than a temperature of the resin, is in contact with the flat surface portion.

9. The discharge circuit according to claim 8, wherein
the resin is provided on both sides of the substrate, and
a thickness of the resin on the cooling member side of the substrate is thinner than a thickness of the resin on an opposite side of the substrate from the cooling member.

10. The discharge circuit according to claim 7, wherein
the thermal conductivity of the resin is 0.6 W/mK or higher.

11. The discharge circuit according to claim 7, wherein
wires which are connected to both ends of the smoothing capacitor, and wires which control current conduction to the resistive elements, extend from the substrate to the outside the resin.
